(19) United States
(12) Patent Application Publication
(10) Pub. No.: US 2026/0230719 A1
(43) Pub. Date: Aug. 6, 2026

(54) ELECTRONIC DEVICE, MANAGEMENT SYSTEM, AND PROGRAM

(71) Applicant: Panasonic Intellectual Property Management Co., Ltd., Osaka (JP)

(72) Inventor: Yuki UEDA, Osaka (JP)

(73) Assignee: Panasonic Intellectual Property Management Co., Ltd., Osaka (JP)

(21) Appl. No.: 19/445,566

(22) Filed: Jan. 11, 2026

(30) Foreign Application Priority Data
Jan. 30, 2025 (JP) 2025-014086

(51) Int. Cl. H04N 23/84; H04N 23/63

(52) U.S. Cl. CPC H04N 23/84; H04N 23/632

(57) ABSTRACT

An electronic device includes a controller and a memory. The controller is configured to: generate color conversion data that defines a correspondence between color information of an image before and after color conversion, based on a parameter set for the color conversion; and store the color conversion data and setting data indicating the set parameter in the memory in association with each other.

### TECHNICAL FIELD

The present disclosure relates to an electronic device, a management system, and a program.

### BACKGROUND ART

JP 2008-270928 A describes an image processing technique for performing color conversion on an image, and particularly discloses that an image processor generates a color conversion data file from a color adjustment parameter designated by a user through an operation input unit. JP 2008-270928 A describes that this color conversion data file includes both low-order three-dimensional grid point data to be used for color conversion processing in an imaging device and high-order three-dimensional grid point data to be used for color conversion processing in a PC application.

### SUMMARY

The present disclosure provides an electronic device, a management system, and a program that can facilitate color conversion desired by a user.

An electronic device according to an aspect of the present disclosure includes a controller and a memory. The controller is configured to generate color conversion data that defines a correspondence between color information of an image before and after color conversion, based on a parameter set for the color conversion. The controller is configured to store the color conversion data and setting data indicating the set parameter in the memory in association with each other.

An electronic device according to another aspect of the present disclosure includes: a controller configured to acquire setting data indicating a parameter set to define first color conversion data that defines a correspondence between color information of an image before and after color conversion; and an input interface configured to receive input of user operation for changing the parameter. The controller generates second color conversion data that defines a correspondence between color information of an image before and after color conversion, based on the changed parameter.

A management system according to an aspect of the present disclosure includes the electronic device according to any of the aspects described above, and a server connected to the electronic device via a network and configured to manage the setting data.

A non-transitory computer-readable storage medium according to an aspect of the present disclosure stores a program for causing a computer to function as the electronic device according to any of the aspects described above.

According to the present disclosure, it is possible to easily implement color conversion desired by a user.

### BRIEF DESCRIPTION OF THE DRAWINGS

FIG. 1 is a block diagram illustrating a configuration of an LUT management system according to an embodiment of the present disclosure;

FIG. 2 is a block diagram illustrating a configuration example of a user terminal according to the embodiment;

FIG. 3 is a block diagram illustrating a configuration example of an LUT management server according to the embodiment;

FIG. 4 shows a configuration example of a digital camera according to the embodiment;

FIG. 5 is a flowchart indicating an example of operation of a creator terminal in the embodiment;

FIG. 6 shows an example of a parameter setting screen to be displayed on a display of the creator terminal;

FIG. 7 shows a data structure of a merge file as an example of a creator LUT and a parameter data set associated with each other;

FIG. 8 is a flowchart indicating an example of operation of the LUT management

server in the embodiment;

FIG. 9 is a flowchart indicating an example of operation of downloading the parameter data set by an end user terminal in the embodiment;

FIG. 10 shows an example of a confirmation screen to be displayed on a display of the end user terminal;

FIG. 11 is a flowchart indicating an example of operation of generating an adjusted LUT by the end user terminal in the embodiment;

FIG. 12 shows an example of a parameter setting screen to be displayed on the display of the end user terminal;

FIG. 13 is a flowchart indicating an example of operation of applying the adjusted LUT to an image by the end user terminal in the embodiment; and

FIG. 14 is a flowchart indicating an example of operation of the digital camera in the embodiment.

### DETAILED DESCRIPTION

Hereinafter, embodiments of the present disclosure will be described with reference to the drawings as appropriate. However, in the detailed description, unnecessary parts in descriptions of the conventional technique and the substantially same configuration may be omitted. The following description and the accompanying drawings are provided so that those skilled in the art can fully understand the present disclosure, and not intended to limit the subject matter of the claims.

### 1. Configuration

### 1-1. LUT Management System

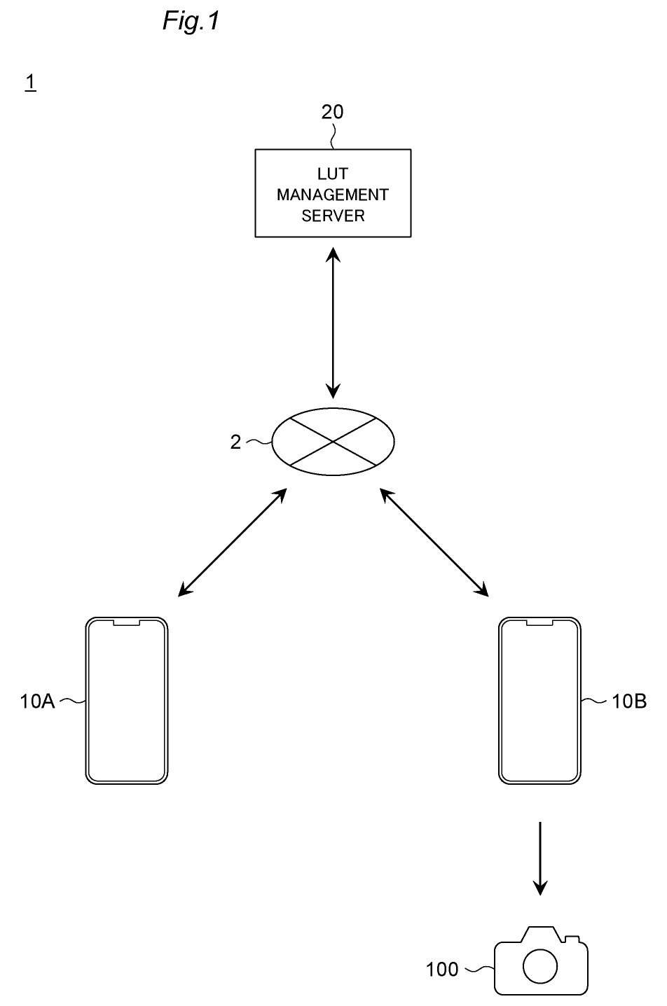

FIG. 1 is a block diagram illustrating a configuration of an LUT management system 1 according to an embodiment of the present disclosure. The LUT management system 1 includes a creator terminal 10A, an LUT management server 20, an end user terminal 10B, and a digital camera 100. The LUT management server 20 is communicably connected to the creator terminal 10A and the end user terminal 10B via a network 2. The digital camera 100 is communicably connected to the end user terminal 10B. The digital camera 100 may be communicably connected to the LUT management server 20, the creator terminal 10A, and the end user terminal 10B via the network 2.

The creator terminal 10A and the end user terminal 10B are, for example, electronic devices such as a smartphone, a tablet terminal, and a personal computer. The creator terminal 10A and the end user terminal 10B may have similar configurations, and hereinafter, the creator terminal 10A and the end user terminal 10B may be collectively referred to as a “user terminal 10”.

The LUT is an example of color conversion data or color grading dataset, and is an array that defines a correspondence between color information before and after conversion, based on a parameter set for converting color information for each pixel in an input image. The LUT is, for example, a three-dimensional lookup table indicating a correspondence between input and output color data including a combination of three colors of RGB. The controller 11 of the user terminal 10 or another image processing apparatus can perform image processing of converting color of the input image into color of an output image by referring to the LUT.

### 1-2. User Terminal

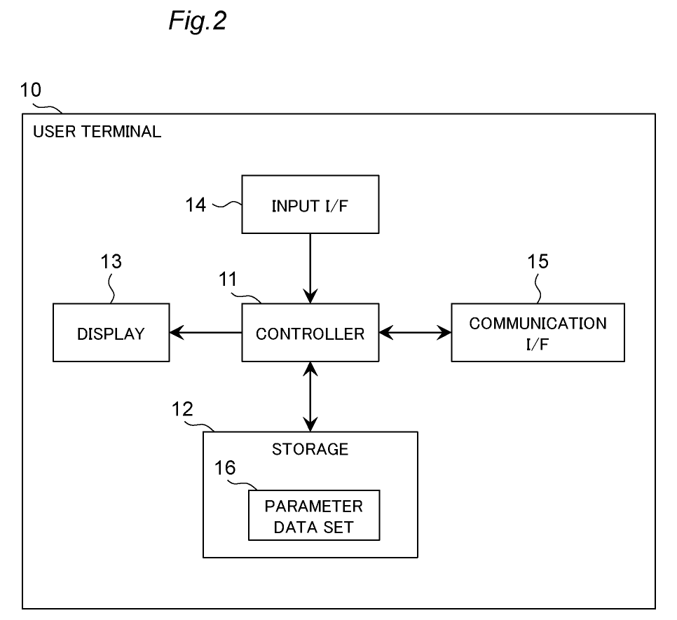

FIG. 2 is a block diagram illustrating a configuration of the user terminal 10. The user terminal 10 includes a controller 11, a storage 12, a display 13, an input interface (I/F) 14, and a communication interface (I/F) 15.

The controller 11 performs information processing to implement functions of the user terminal 10. Such information processing is implemented, for example, by the controller 11 operating according to a program stored in the storage 12. The controller 11 includes an arithmetic circuit that performs arithmetic operation for information processing. For example, the controller 11 includes, for example, a circuit such as a CPU, an MPU or an FPGA.

The storage 12 is a recording medium that records various kinds of information including a program necessary for implementing a function of the user terminal 10, a parameter data set 16 to be described later, the LUT, and the like. The storage 12 is implemented by, for example, a semiconductor storage device such as a flash memory or a solid state drive (SSD), a magnetic storage device such as a hard disk drive (HDD), or other recording media alone or in combination thereof. The storage 12 may include, for example, a volatile memory such as an SRAM or a DRAM.

The display 13 is a display device capable of displaying information, and includes, for example, a liquid crystal display, an organic EL display, and the like.

The input interface 14 is an example of an input unit that connects the user terminal 10 and input equipment in order to input information from input equipment such as a touch panel, a touch pad, a keyboard, a mouse, or a pointing device to the user terminal 10. For example, the input interface 14 receives operation by a user via the input equipment.

The communication interface 15 is a communication circuit that performs wireless or wired communication in accordance with communication standards. The communication interface 15 can be connected to a network such as an intranet or the Internet, and can receive information from an external device such as an LUT management server 20 and transmit the information to the external device. Alternatively, the communication interface 15 may directly communicate with an external device without a network.

### 1-3. LUT Management Server

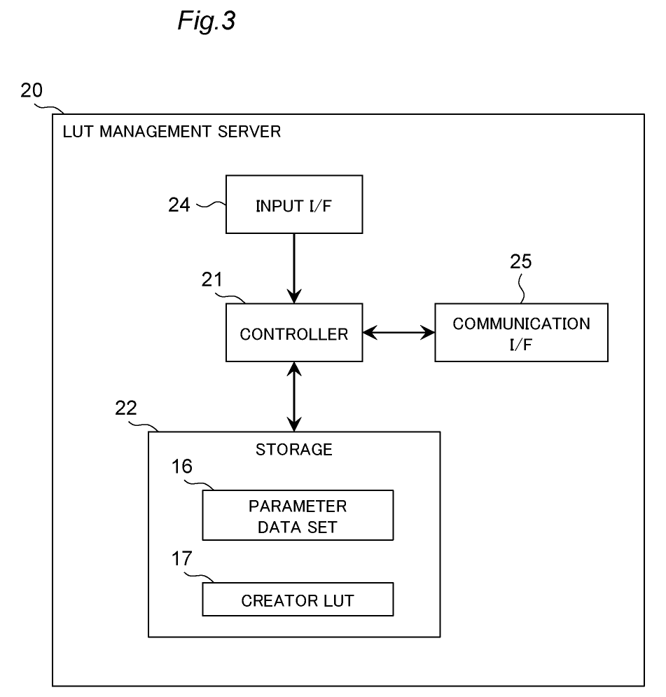

FIG. 3 is a block diagram illustrating a configuration example of the LUT management server 20. The LUT management server 20 includes a controller 21, a storage 22, an input interface 24, and a communication interface 25. The LUT management server 20 may be, for example, a cloud server.

The controller 21 implements a function of the LUT management server 20, for example, by operating according to a program stored in the storage 22. The storage 22 is a recording medium that records various types of information including programs necessary for implementing a function of the storage 22. The storage 22 stores data such as a parameter data set 16 and a creator LUT 17, which will be described later, received from the creator terminal 10A.

The input interface 24 connects the LUT management server 20 and the input equipment in order to input information from the input equipment to the LUT management server 20. The communication interface 25 performs wireless or wired communication in accordance with a communication standard. The controller 21, the storage 22, the input interface 24, and the communication interface 25 may have configurations similar to those of the controller 11, the storage 12, the input interface 14, and the communication interface 15 of the user terminal 10, respectively.

### 1-4. Digital Camera

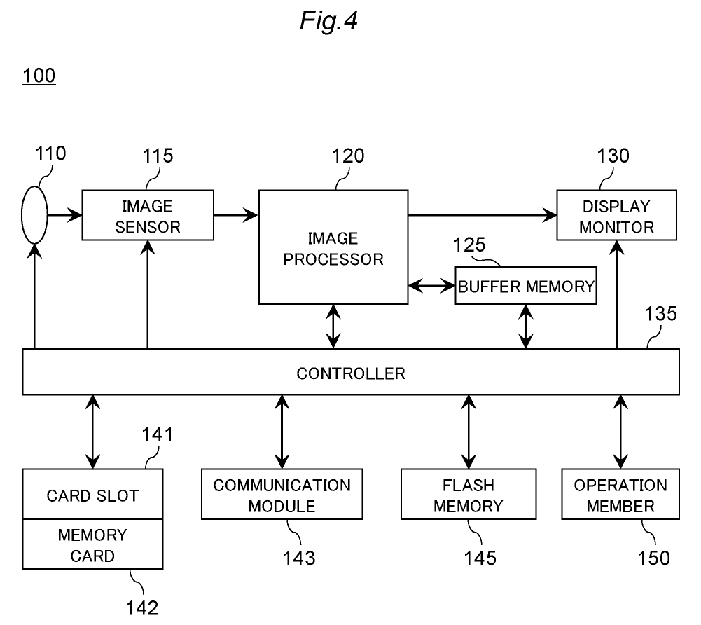

FIG. 4 shows a configuration example of the digital camera 100. The digital camera 100 captures a subject image to generate image data. The image data generated by the digital camera 100 includes moving image data and still image data.

The digital camera 100 captures a subject image formed via an optical system 110 with an image sensor 115 to generate original image data (RAW data). An image processor 120 performs various kinds of processing on the RAW data generated by the image sensor 115 to generate image data. A controller 135 records the image data generated by the image processor 120 in a flash memory 145 or a memory card 142 inserted into a card slot 141. In addition, the controller 135 can display (reproduce) the image data recorded in the flash memory 145 or the memory card 142 on a display monitor 130 according to operation of an operation member 150 by the user.

The optical system 110 includes a focus lens, a zoom lens, an optical image stabilization lens (OIS), a diaphragm, a shutter, and the like. The various lenses included in the optical system 110 may be constituted with any number of lenses or any number of groups.

The image sensor 115 captures a subject image formed through the optical system 110 to generate RAW data. The image sensor 115 generates image data of a new frame at a predetermined frame rate (for example, 30 frames/second). A generation timing of the RAW data and electronic shutter operation in the image sensor 115 are controlled by the controller 135.

The image processor 120 performs various kinds of processing on the RAW data output from the image sensor 115 to generate image data. In addition, the image processor 120 performs various kinds of processing on the image data read from the memory card 142 to generate an image to be displayed on the display monitor 130. Examples of the various kinds of processing include, but are not limited to, white balance correction, gamma correction, YC conversion processing, electronic zoom processing, compression processing, decompression processing, image processing using a lookup table (LUT), and the like. The image processor 120 may be constituted with a hard-wired electronic circuit or a microcomputer using a program.

The display monitor 130 is a display device such as a liquid crystal display or an organic EL display configured to display information. For example, the display monitor 130 displays an image based on the image data processed by the image processor 120. In addition, the display monitor 130 displays a menu screen for the user to confirm setting of the digital camera 100.

The controller 135 integrally controls the entire operation of the digital camera 100. The controller 135 may include a processor configured to implement a predetermined function by executing a program. For example, the controller 135 includes a circuit such as a CPU, an MPU, or an FPGA. Although not illustrated, the controller 135 includes a ROM. The ROM stores various programs like autofocus control (AF control) to be executed by the controller 135. In addition, the controller 135 incorporates a RAM (not shown) that functions as a work area of the CPU.

A buffer memory 125 is a recording medium that functions as a work memory of the image processor 120 and the controller 135. The buffer memory 125 is implemented by a DRAM, or the like.

The memory card 142 is detachably inserted into the card slot 141. The card slot 141 can be electrically and mechanically connected to the memory card 142. The memory card 142 is an external memory including a recording element such as a flash memory therein. The memory card 142 can store data such as an LUT and image data generated by the image processor 120.

A communication module 143 is a communication circuit that performs wireless or wired communication in accordance with a communication standard. For example, the digital camera 100 can communicate with a communication network such as the Internet and/or another equipment equipped with a Wi-Fi module via the communication module 143. The digital camera 100 may directly communicate with another equipment via the communication module 143 or may communicate via an access point.

The flash memory 145 is a non-volatile recording medium. The flash memory 145 can store various kinds of data such as an LUT and image data described later.

The operation member 150 is a general term of a user interface such as a hardware key and a software key of the digital camera 100 and receives operation by the user. The operation member 150 includes, for example, a button, a mode dial, a touch panel, and a switch. If operation by the user is received, the operation member 150 transmits an operation signal according to the user operation to the controller 135.

The operation member 150 includes various buttons such as an information display switching button, a menu/setting button, a return button, a determination button, and a cursor button. The cursor button includes push-buttons respectively corresponding to up, down, left, and right, and in a case where the button is pressed by the user, a selection area displayed on the display monitor 130, a cursor, and the like, can be moved. The operation using these various buttons may be configured to be executable not only by physical buttons but also by a touch panel.

### 2. Operation

### 2-1. Overall System Operation

Hereinafter, operation of the LUT management system 1 according to the present embodiment will be described.

A creator adjusts parameters such as hue of an image using the creator terminal 10A, and creates a LUT (hereinafter, referred to as a “creator LUT”) that defines a correspondence before and after conversion of color information in the image. The creator terminal 10A can generate a parameter data set 16 that defines the adjusted parameters, and transmits (uploads) the creator LUT 17 and the parameter data set 16 to the LUT management server 20 in association with each other (see FIG. 1 and FIGS. 5 and 6 described later.).

The above-described operation by the creator terminal 10A can be implemented by, for example, application software. The application software may operate in the creator terminal 10A or may operate in an external device such as an application server. Such an external device may be the LUT management server 20.

The end user can confirm an effect of each of the plurality of creator LUTs 17 created by one or more creators via the end user terminal 10B. As a result, the end user can select a favorite creator LUT 17 and receive (download) the parameter data set 16 corresponding to the selected creator LUT 17 from the LUT management server 20.

The end user terminal 10B can reproduce the parameters of the LUT created by the creator based on the parameter data set 16. Further, the end user may adjust the parameters to generate the adjusted LUT by using the end user terminal 10B. In this way, the end user can create an LUT customized to his/her preference, for example, by finely adjusting the LUT created by the creator.

As described above, the LUT management system 1 according to the present embodiment has an advantage also for the end user who does not necessarily have specialized knowledge about the LUT like a creator. In other words, even if the end user desires to create the LUT by himself/herself, in a case where the end user does not have specialized knowledge, the end user may not know which parameter should be changed and how to change to create the desired LUT. In such a case, it is difficult for the end user to create an LUT matching his/her preference. Such an end user can reproduce the parameters of the LUT created by the creator by using the end user terminal 10B in the present embodiment, and eventually, can obtain an image subjected to processing of converting color information according to the preferences of the end user.

The above-described operation by the end user terminal 10B can be implemented by, for example, application software. The application software for implementing the operation of the end user terminal 10B may be the same as or different from the application software for implementing the operation of the creator terminal 10A.

### 2-2. Operation of Creator Terminal

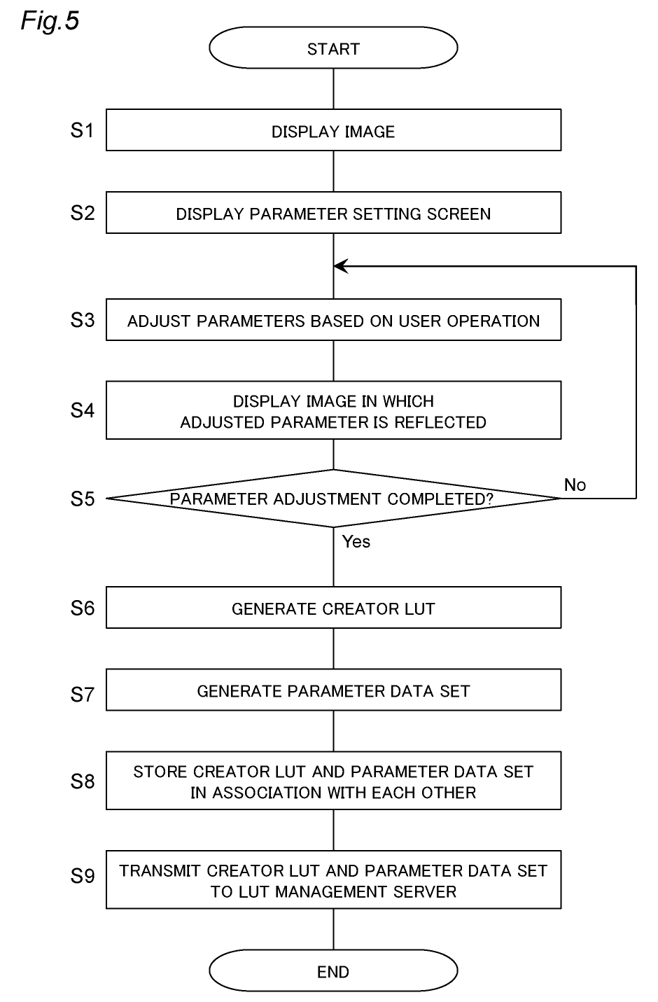

The operation of the creator terminal 10A in the present embodiment will be described with reference to FIGS. 5 to 7. FIG. 5 is a flowchart indicating an example of operation of the creator terminal 10A in the present embodiment. The processing in FIG. 5 is executed by, for example, the controller 11 of the creator terminal 10A.

In FIG. 5, first, the creator terminal 10A displays an image on the display 13 in response to, for example, input of operation of the creator selecting an image (S1).

Next, in response to the operation input by the creator, the creator terminal 10A displays a parameter setting screen (S2).

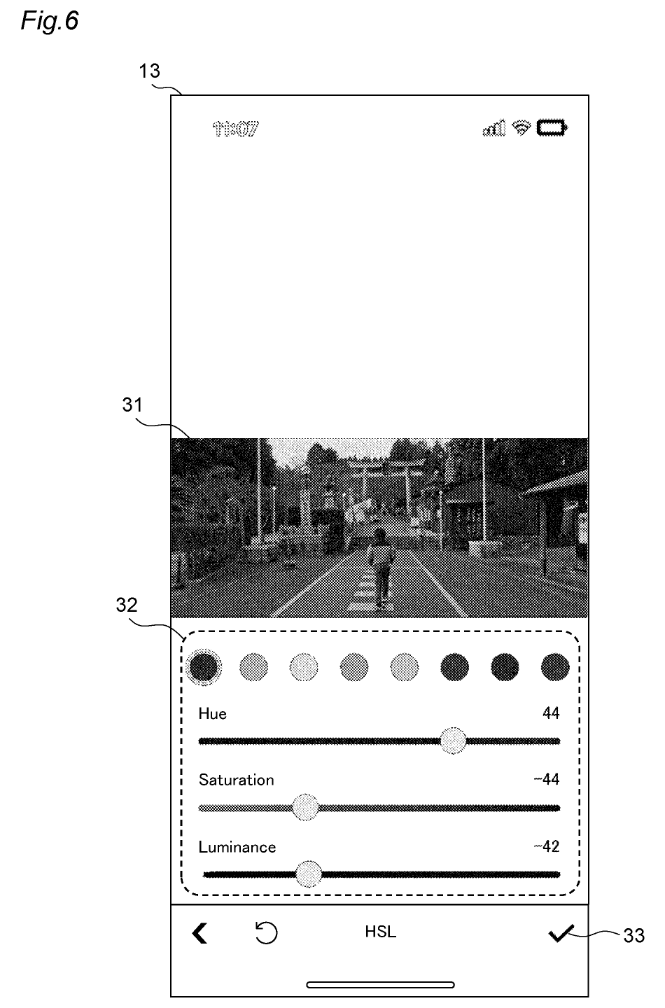

FIG. 6 shows an example of the parameter setting screen displayed on the display 13 of the creator terminal 10A. An image 31 and a parameter adjustment area 32 are displayed on the parameter setting screen. In the parameter adjustment area 32, parameters to be set and a user interface such as sliders and input windows for adjusting the parameters are displayed. In the screen illustrated in FIG. 6, hue, saturation, and luminance are displayed as such parameters to be set. The parameters are not limited thereto, and may include, for example, at least one of exposure, contrast, white balance, highlight, shadow, or split tone in addition to or in place of hue, saturation, and luminance.

Returning to FIG. 5, the creator terminal 10A receives input of user operation for setting the parameters via the input interface 14, and adjusts the parameters based on the user operation (S3). The creator terminal 10A displays, on a display 13, an image in which the adjusted parameter is reflected (S4). In the example of FIG. 6, in response to the creator adjusting the parameters by the user operation of moving the sliders, the adjusted parameters are reflected in the image 31. Therefore, the creator can confirm the result of the parameter adjustment via the image 31.

The creator terminal 10A determines whether or not the parameter adjustment has been completed (S5). In FIG. 6, for example, in response to the creator tapping a complete icon 33, the creator terminal 10A determines that the parameter adjustment has been completed.

In a case where the parameter adjustment has not been completed (No in S5), processing from step S3 to step S5 is executed again.

If the parameter adjustment has been completed (Yes in S5), the creator terminal 10A generates the creator LUT based on the adjusted parameters (S6). Furthermore, the creator terminal 10A generates the parameter data set 16 as setting data indicating the adjusted parameters (S7).

The creator terminal 10A stores the creator LUT generated in step S6 and the parameter data set 16 generated in step S7 in the storage 12 in association with each other (S8). The creator terminal 10A transmits the creator LUT and the parameter data set 16 associated with each other to the LUT management server 20 via the network 2 (S9).

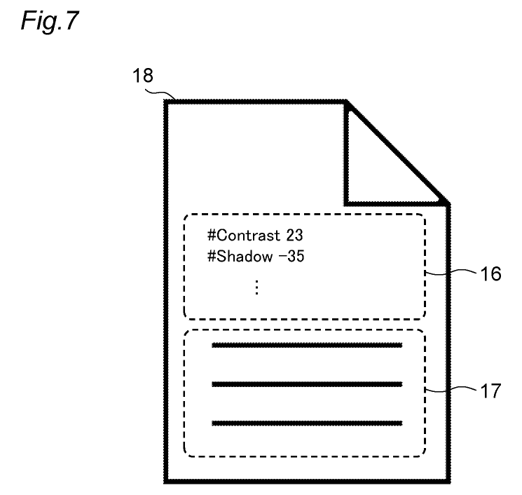

FIG. 7 illustrates a data structure of a merge file 18, which represents an example of a pair of the creator LUT 17 and the parameter data set 16 that are associated with each other. As illustrated in FIG. 7, the merge file 18 includes a first portion describing the parameter data set 16 and a second portion describing the creator LUT 17. However, the manner in which the creator LUT 17 and the parameter data set 16 are associated with each other is not limited to this example. For example, the creator LUT 17 and the parameter data set 16 may include, in a header or other data area, pointers, IDs, or other identification information for specifying each other.

### 2-3. Operation of LUT Management Server

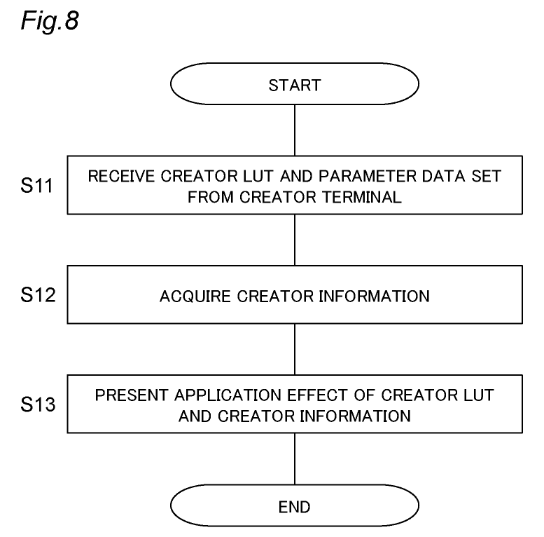

FIG. 8 is a flowchart indicating an example of operation of the LUT management server 20 in the present embodiment. The processing in FIG. 8 is executed by the controller 21 (see FIG. 3) of the LUT management server 20, for example.

In FIG. 8, the LUT management server 20 receives the creator LUT 17 and the parameter data set 16 transmitted by the creator terminal 10A in step S9 of FIG. 5 (S11).

Furthermore, the LUT management server 20 acquires creator information indicating the creator who has created the creator LUT 17 (S12). For example, the creator information is transmitted by the creator terminal 10A in step S9 of FIG. 5 together with the creator LUT 17 and the parameter data set 16.

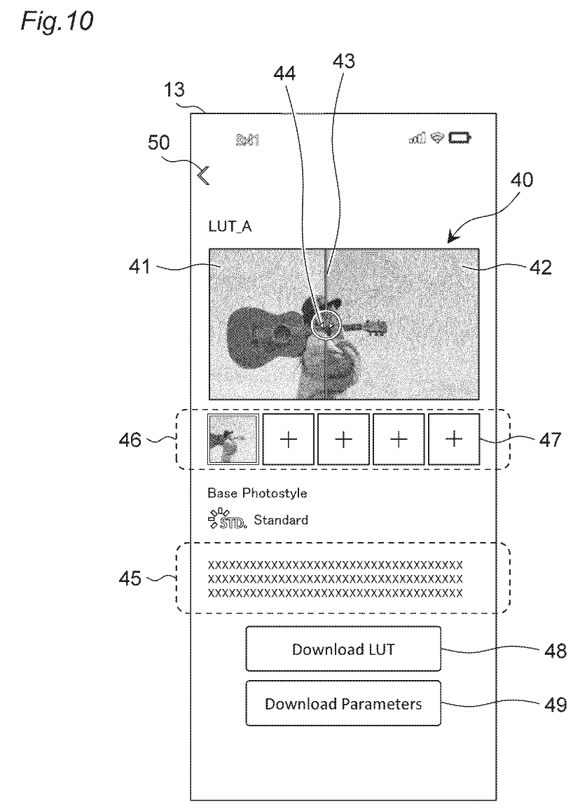

Next, the LUT management server 20 presents an application effect of the creator LUT 17 and the creator information (S13). For example, the application effect of the creator LUT 17 and the creator information are displayed on the display 13 of the end user terminal 10B via the application software (see FIG. 10 to be described later).

### 2-4. Operation of End User Terminal

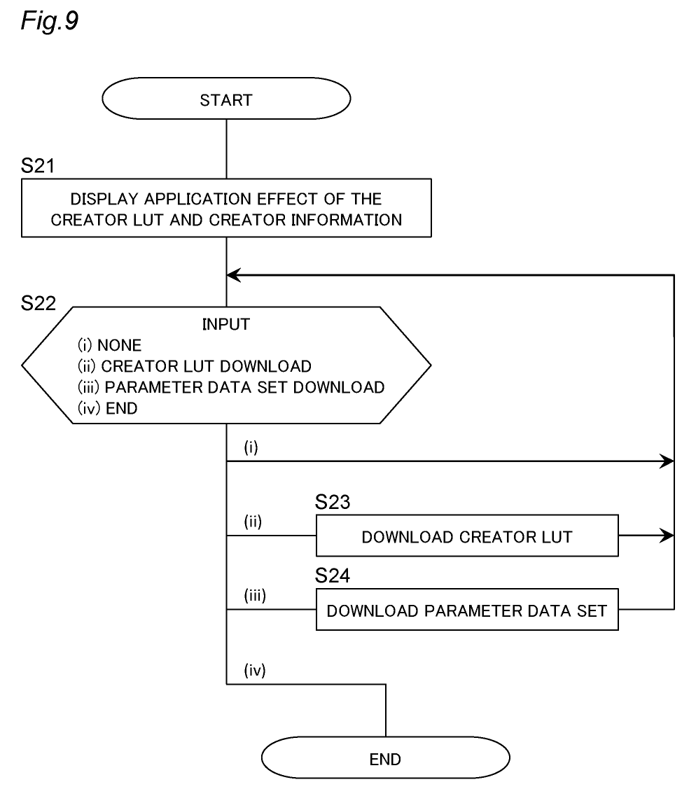

The operation of the end user terminal 10B in the present embodiment will be described with reference to FIGS. 9 to 13.

### 2-4-1. Confirmation and Download of Application Effect of Creator LUT

FIG. 9 is a flowchart indicating an example of operation of downloading the parameter data set 16 by the end user terminal 10B in the present embodiment. The processing in FIG. 9 is executed by, for example, the controller 11 of the end user terminal 10B.

In FIG. 9, the end user terminal 10B displays a confirmation screen indicating the application effect of the creator LUT 17 and the creator information on the display 13 via the application software (S21).

FIG. 10 shows an example of the confirmation screen to be displayed on the display 13 of the end user terminal 10B in step S21.

In a comparison display area 40 of the confirmation screen of FIG. 10, a sample image 41 and an LUT applied image 42 indicating the application effect of the creator LUT 17 are compared and displayed. In the example illustrated in FIG. 10, a boundary line 43 is displayed in the comparison display area 40, the sample image 41 is displayed on the left side of the boundary line 43, and the LUT applied image 42 is displayed on the right side of the boundary line 43. The end user can move a position of the boundary line 43 to the left and right by dragging a position adjustment button 44 for adjusting the position of the boundary line 43. The end user can confirm the application effect of the creator LUT 17 by viewing the confirmation screen as described above.

The sample image 41 and the LUT applied image 42 are stored in the storage 22 of the LUT management server 20, for example, and are displayed on the display 13 of the end user terminal 10B via the application software.

Alternatively, the sample image 41 may be stored in the storage 12 of the end user terminal 10B, and the LUT applied image 42 may be prepared by the end user terminal 10B as an image indicating the effect obtained by applying the creator LUT 17 to the sample image 41. In this case, the end user terminal 10B downloads a small-size LUT having a relatively small data size without downloading the creator LUT 17 itself having a relatively large data size from the LUT management server 20. The end user terminal 10B displays the effect obtained by applying the small-size LUT to the image data to the end user through the display 13. Thus, the end user can indirectly confirm the effect of the creator LUT 17 by confirming the application effect of the small-size LUT.

The small-size LUT corresponding to the creator LUT 17 is obtained, for example, by compressing the creator LUT 17. An example of a method for compressing the LUT is thinning out grid points (grids) of the LUT. For example, in a case where the three-dimensional LUT corresponds to input/output of a 10-bit color space, the color space has 1024 grid points per dimension. The controller 21 compresses the LUT by thinning out the number of grid points per dimension and setting the number of the thinned out grid points to, for example, 128, 64, 32, 16, or the like. The table thus thinned out may be complemented by a known method such as tetrahedron interpolation.

A description text 45 explaining the contents of the creator LUT 17 is displayed on the confirmation screen illustrated in FIG. 10. The description text 45 may include creator information. By reading the description text 45, the end user can know the content of the effect, and the like, of the creator LUT 17 under consideration.

A sample image selection menu 46 from which the sample image 41 displayed in the comparison display area 40 can be selected is displayed on the confirmation screen illustrated in FIG. 10. In the example of FIG. 10, five thumbnail images (preview images) each indicating the sample image 41 can be displayed in the sample image selection menu 46. With the sample image selection menu 46, the end user can confirm the effect of the creator LUT 17 on various sample images 41 without causing the screen to transition from the confirmation screen.

In the sample image selection menu 46 of the confirmation screen of FIG. 10, four add buttons 47 for adding the selectable sample image 41 to the sample image selection menu 46 are displayed. The end user can add the sample image 41 to the sample image selection menu 46 by clicking or tapping one of the add buttons 47.

Returning to FIG. 9, the end user terminal 10B receives input of user operation by the end user (S22). The end user terminal 10B executes various kinds of operation according to the input.

For example, as illustrated in FIG. 9, the end user terminal 10B executes the following operations (i) to (iv) in response to the input of the user operation.

(i) In a case where there is no input of user operation, the processing returns to step S22.

(ii) If user operation of giving an instruction to download the creator LUT 17 is input, the creator LUT 17 is downloaded (S23), and the processing returns to step S22. In the example illustrated in FIG. 10, if the “download LUT” button 48 is tapped, the processing in step S23 is executed.

(iii) If user operation of giving an instruction to download the parameter data set 16 is input, the parameter data set 16 is downloaded (S24), and the processing returns to step S22. In the example illustrated in FIG. 10, if the “download parameter” button 49 is tapped, the processing in step S24 is executed.

(iv) If user operation of giving an instruction to end the download operation is input, the flow of FIG. 9 is ended. In the example illustrated in FIG. 10, if the “return” icon 50 is tapped, the flow of FIG. 9 is completed, and the end user terminal 10B causes the confirmation screen to transition to another screen.

As a result, the end user can acquire data according to his/her intention from the LUT management server 20. For example, in a case where the end user desires to use the creator LUT 17 without correction, the end user downloads the creator LUT 17 (S23). On the other hand, the end user can download the parameter data set 16 (S24), reproduce the parameters of the creator LUT 17 based on the parameter data set, and further adjust the parameters as described later to generate the adjusted LUT.

### 2-4-2. Parameter Adjustment and Generation of Adjusted LUT

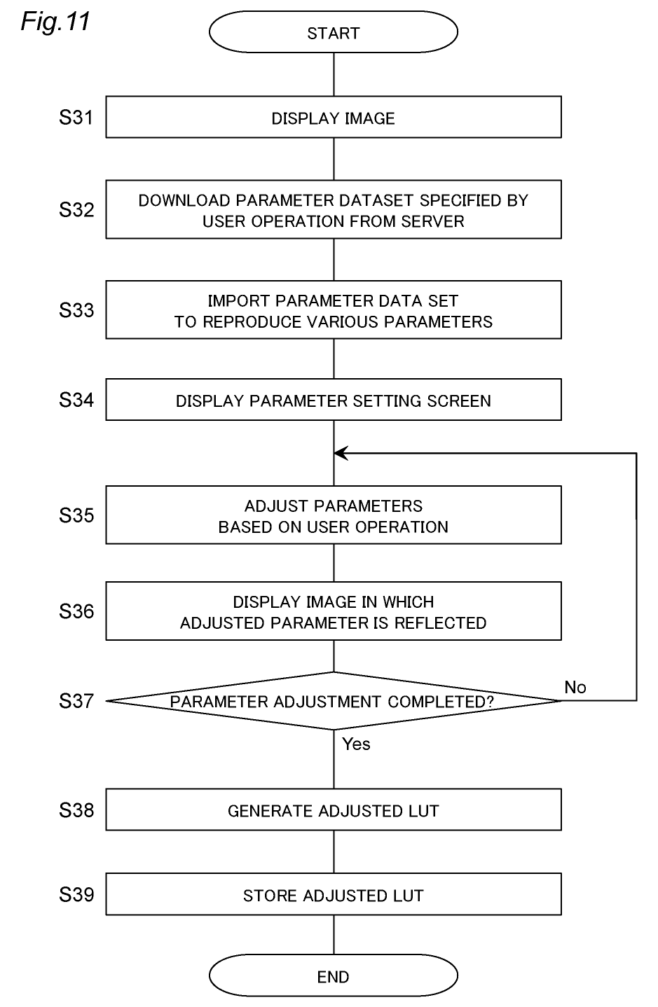

FIG. 11 is a flowchart indicating an example of operation of generating the adjusted LUT by the end user terminal 10B in the present embodiment. The processing of FIG. 11 is executed by the controller 11 of the end user terminal 10B, for example.

In FIG. 11, first, the end user terminal 10B displays an image on the display 13, for example, in response to input of operation of the end user selecting an image (S31).

In a case where the user operation of giving an instruction to download the parameter data set 16 is input as in (iii) in step S22 in FIG. 9, the end user terminal 10B downloads the parameter data set 16 from the LUT management server 20 (S32).

In this case, the end user terminal 10B imports the parameter data set 16 to reproduce various parameters in the creator LUT 17 created by the creator (S33).

Next, in response to the input of the operation by the end user, the end user terminal 10B displays a parameter setting screen (S34). The end user terminal 10B receives input of user operation for setting parameters via the input interface 14, and adjusts the parameters based on the user operation (S35). The end user terminal 10B displays an image in which the adjusted parameter is reflected on the display 13 (S36).

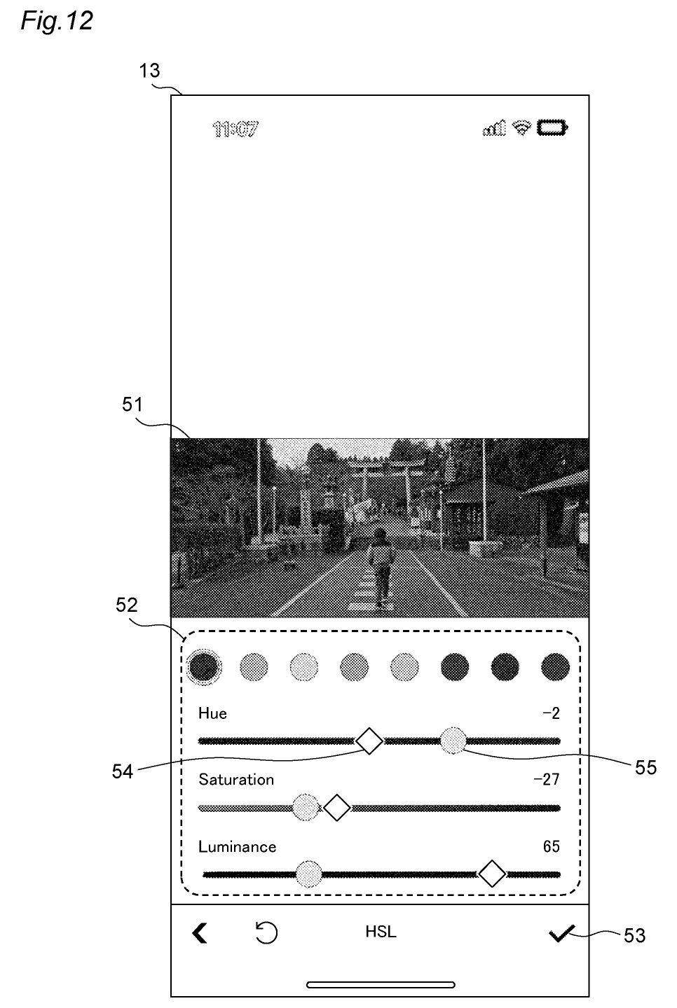

FIG. 12 shows an example of the parameter setting screen to be displayed on the display 13 of the end user terminal 10B. An image 51 and a parameter adjustment area 52 are displayed on the parameter setting screen. Parameters to be set and sliders 54 for adjusting the parameters are displayed in the parameter adjustment area 52. The parameters that can be set in the parameter adjustment area 52 are, for example, the same as the parameters that can be set in the parameter adjustment area 32 in FIG. 6.

The end user can change the parameters by moving the sliders 54 left and right. As illustrated in FIG. 12, an original parameter display 55 for displaying the parameters before being changed, that is, the parameters set by the creator may be displayed in the parameter adjustment area 52. As a result, after moving the sliders 54 left and right, the end user can confirm the parameters before being changed even if the parameters before being changed are not stored.

Returning to FIG. 11, the end user terminal 10B determines whether parameter adjustment has been completed (S37). In FIG. 12, for example, if the end user taps the complete icon 53, the end user terminal 10B determines that the parameter adjustment has been completed.

In a case where the parameter adjustment has not been completed (No in S37), the processing from step S35 to step S37 is executed again.

If the parameter adjustment has been completed (Yes in S37), the end user terminal 10B generates the adjusted LUT based on the adjusted parameters (S38), and stores the generated adjusted LUT in the storage 12 (S39).

### 2-4-3. Application of Adjusted LUT to Image

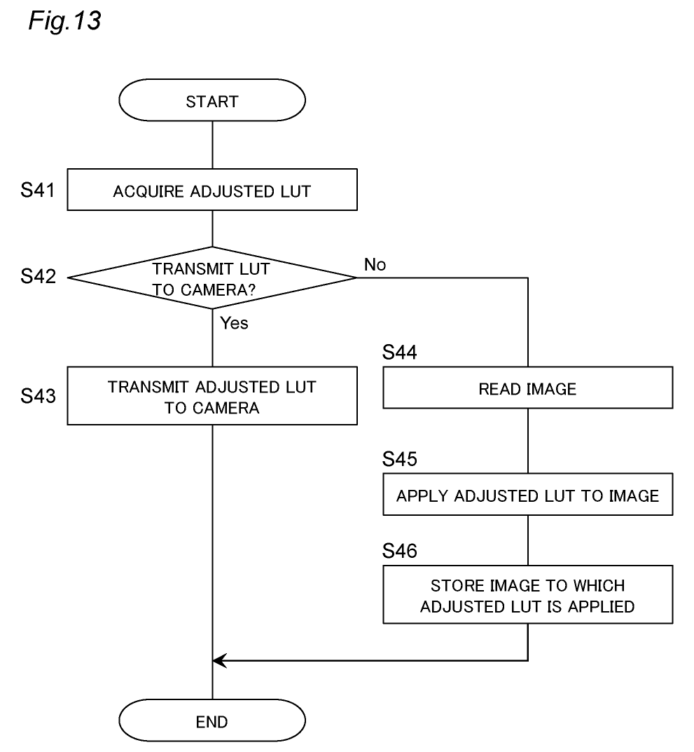

FIG. 13 is a flowchart indicating an example of operation of applying the adjusted LUT to the image by the end user terminal 10B in the present embodiment. The processing in FIG. 13 is executed by the controller 11 of the end user terminal 10B, for example.

In FIG. 13, the end user terminal 10B acquires the adjusted LUT from, for example, the storage 12 (S41).

Next, the end user terminal 10B determines whether or not to transmit the acquired adjusted LUT to the digital camera 100 (S42). If it is determined to transmit the adjusted LUT to the digital camera 100 (Yes in S42), the end user terminal 10B transmits the adjusted LUT to the digital camera 100 (S43). For example, if the end user taps a button for transmitting the adjusted LUT to the digital camera 100, the end user terminal 10B determines to transmit the adjusted LUT to the digital camera 100. In this case, the operation of applying the adjusted LUT is executed by the digital camera 100.

In a case where the adjusted LUT is not transmitted to the digital camera 100 (No in S42), for example, the end user terminal 10B executes the operation from step S44 to step S46 for applying the adjusted LUT to the image in the end user terminal 10B. Specifically, the end user terminal 10B reads the image from the storage 12 or an external device (S44), and applies the adjusted LUT to the read image (S45). The end user terminal 10B stores the image to which the adjusted LUT is applied in the storage 12 (S46).

### 2-5. Digital Camera

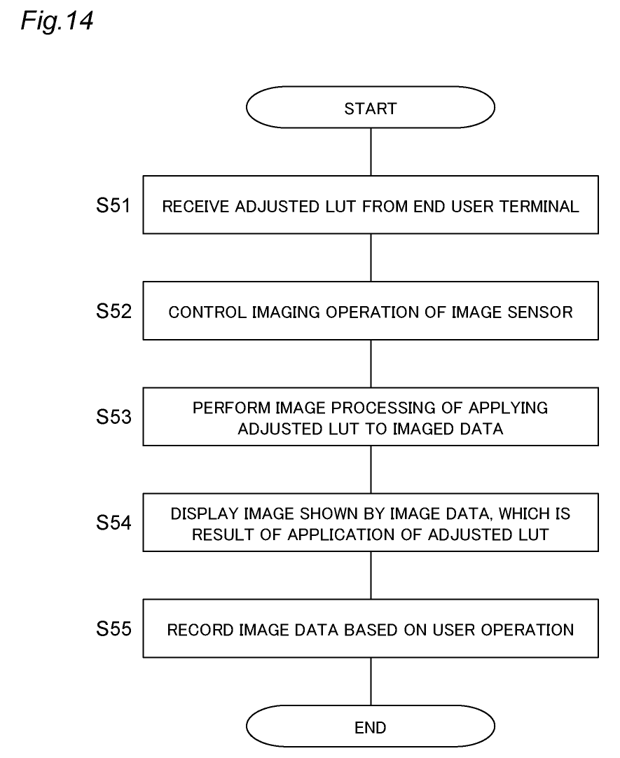

Hereinafter, operation of applying the adjusted LUT by the digital camera 100 will be described. FIG. 14 is a flowchart indicating operation of the digital camera 100 in the present embodiment.

The controller 135 of the digital camera 100 receives the adjusted LUT from the end user terminal 10B via the communication module 143, for example (S51).

The controller 135 controls imaging operation of the image sensor 115 (S52). Under the control of the controller 135, the image sensor 115 captures a subject image formed via the optical system 110 to generate RAW data, and outputs the RAW data to the image processor 120.

Next, under the control of the controller 135, the image processor 120 applies the adjusted LUT received in step S51 to the RAW data (S53). As a result of the application, image data to which the adjusted LUT is applied is generated.

Next, under the control of the controller 135, the image processor 120 outputs the image indicated by the image data generated in step S53 to the display monitor 130 as a live view image (S54).

The controller 135 records the image data to which the adjusted LUT is applied in a flash memory 145 or a memory card 142 inserted into the card slot 141 based on user operation receiveed by the operation member 150, for example, a shutter button (S55). The image data may be moving image data or still image data.

As described above, the digital camera 100 according to the present embodiment can output the image data to which the adjusted LUT adjusted according to the preference of the end user has been applied, and can execute output of the image data to which the LUT has been applied in real time.

### 3. Conclusion

As described above, the creator terminal 10A, which is an example of the electronic device in the present embodiment, includes the controller 11 and the storage 12 (an example of a memory). The controller 11 generates the creator LUT 17 (an example of color conversion data) that defines a correspondence between color information of an image before and after conversion based on the parameter set for the color conversion (S6). The creator terminal 10A stores the creator LUT 17 and the parameter data set 16, which is an example of setting data indicating set parameters, in the storage 12 in association with each other (S8).

According to the creator terminal 10A described above, it is possible to easily implement color conversion desired by the user.

The creator terminal 10A may further include the communication interface 15 configured to communicate with the LUT management server 20 which is an example of an external device. The controller 11 may be configured to transmit the parameter data set 16 to the LUT management server 20 via the communication interface 15. According to this configuration, the parameter data set 16 can be easily provided to the outside via the LUT management server 20. For example, the end user can acquire the parameter data set 16 and easily obtain an image subjected to processing of converting color information according to his/her preference.

The creator terminal 10A may further include the input interface 14 that is an example of the input interface that receives input of user operation for setting parameters. According to this configuration, the user such as the creator can set parameters, and the parameter data set 16 according to his/her intention can be created.

The creator terminal 10A may further include the display 13 that is an example of the display that displays the parameters and the image in which the color information has been converted based on the set parameters. According to this configuration, the user such as the creator can create the parameter data set 16 according to his/her intention while viewing the parameters and the image in which the color information has been converted.

The end user terminal 10B which is an example of the electronic device in the present embodiment includes the controller 11 and the input interface 14 which is an example of the input interface. The controller 11 acquires the parameter data set 16. The parameter data set 16 indicates parameters set so as to define the creator LUT 17 (an example of first color conversion data) that defines a correspondence before and after conversion of the color information in the image. The input interface 14 receives input of user operation of changing parameters. The controller 11 generates the adjusted LUT (an example of second color conversion data) that defines a correspondence before and after conversion of the color information in the image based on the changed parameters (S38).

According to the end user terminal 10B described above, color conversion desired by the user can be easily implemented.

The end user terminal 10B may further include the communication interface 15 capable of communicating with the LUT management server 20, which is an example of the external device. The controller 11 receives the parameter data set 16 from the LUT management server 20 via the communication interface 15. Also with this configuration, it is possible to easily obtain the image subjected to processing of converting color information according to the parameters.

The end user terminal 10B may further include the display 13 that is an example of the display that displays the changed parameters and the image in which the color information has been converted based on the changed parameters. According to this configuration, the user such as the end user can create the parameter data set according to his/her preference while viewing the changed parameters and the image in which the color information has been converted.

In the end user terminal 10B, the display 13 may further display the parameters before being changed by the user operation. As a result, even if the user such as the end user does not store the parameters before being changed, for example, the user can create the parameter data set according to his/her preference while confirming the parameters before being changed.

### 4. Other Embodiments

As described above, the embodiments have been described as examples of the technology in the present disclosure. However, the technology in the present disclosure is not limited thereto, and can also be applied to embodiments in which changes, substitutions, additions, omissions, and the like, are appropriately made. In addition, it is also possible to combine the components described in the above embodiments to form a new embodiment. Thus, other embodiments will be exemplified below.

An example has been described in the above embodiments where the creator terminal 10A and the end user terminal 10B are cited as an example of the electronic device, and an example in which the end user terminal 10B and the digital camera 100 are communicably connected. However, the present disclosure is not limited thereto, and the electronic device may be the digital camera 100. For example, instead of the end user terminal 10B of the above embodiments, the digital camera 100 may be connected to the LUT management server 20 via the network 2 and may receive the parameter data set 16 from the LUT management server 20. Furthermore, instead of the creator terminal 10A of the above embodiments, the creator can create the creator LUT 17 using the digital camera 100.

An example has been described in the above embodiments where the creator terminal 10A uploads the creator LUT 17 and the parameter data set 16 to the LUT management server 20 in association with each other, but the present disclosure is not limited thereto. For example, the creator terminal 10A may upload only the parameter data set 16 to the LUT management server 20, and the end user terminal 10B may receive the parameter data set 16 from the LUT management server 20. Also with such an aspect, the end user can reproduce the parameters of the LUT created by the creator based on the parameter data set 16.

### 5. Example of Aspects

Hereinafter, various aspects according to the present disclosure will be listed.

Aspect 1 according to the present disclosure provides an electronic device including: a controller and a memory, wherein the controller is configured to:

generate color conversion data that defines a correspondence between color information of an image before and after color conversion, based on a parameter set for the color conversion, and

store the color conversion data and setting data indicating the set parameter in the memory in association with each other.

Aspect 2 provides the electronic device according to Aspect 1, further including a communication interface configured to communicate with an external device, wherein

the controller is configured to transmit the setting data to the external device via the communication interface.

Aspect 3 provides the electronic device according to Aspect 1, further including an input interface configured to receive input of user operation for setting the parameter.

Aspect 4 provides the electronic device according to Aspect 3, further including a display configured to display the parameter and an image in which the color information is converted based on the set parameter.

Aspect 5 provides an electronic device including:

a controller configured to acquire setting data indicating a parameter set to define first color conversion data that defines a correspondence between color information of an image before and after color conversion; and

an input interface configured to receive input of user operation for changing the parameter, wherein

the controller generates second color conversion data that defines a correspondence between color information of an image before and after color conversion, based on the changed parameter.

Aspect 6 provides the electronic device according to Aspect 5, further including a communication interface configured to communicate with an external device, wherein

the controller is configured to receive the setting data from the external device via the communication interface.

Aspect 7 provides the electronic device according to Aspect 5, further including a display configured to display the changed parameter and an image in which color information is converted based on the changed parameter.

Aspect 8 provides the electronic device according to Aspect 7, wherein the display is further configured to display the parameter before being changed by the user operation.

Aspect 9 provides a management system including:

the electronic device according to Aspect 1; and

a server connected to the electronic device via a network and configured to manage the setting data.

Aspect 10 provides a non-transitory computer-readable storage medium storing program for causing a computer to operate as the electronic device according to Aspect 1.

The concept of the present disclosure can be applied to an electronic device and a management system including the electronic device.

What is claimed is:

1. An electronic device comprising: a controller and a memory, wherein the controller is configured to:
generate color conversion data that defines a correspondence between color information of an image before and after color conversion, based on a parameter set for the color conversion; and
store the color conversion data and setting data indicating the set parameter in the memory in association with each other.

2. The electronic device according to claim 1, further comprising a communication interface configured to communicate with an external device, wherein
the controller is configured to transmit the setting data to the external device via the communication interface.

3. The electronic device according to claim 1, further comprising an input interface configured to receive input of user operation for setting the parameter.

4. The electronic device according to claim 3, further comprising a display configured to display the parameter and an image in which the color information is converted based on the set parameter.

5. An electronic device comprising:
a controller configured to acquire setting data indicating a parameter set to define first color conversion data that defines a correspondence between color information of an image before and after color conversion; and
an input interface configured to receive input of user operation for changing the parameter, wherein
the controller generates second color conversion data that defines a correspondence between color information of an image before and after color conversion, based on the changed parameter.

6. The electronic device according to claim 5, further comprising a communication interface configured to communicate with an external device, wherein
the controller is configured to receive the setting data from the external device via the communication interface.

7. The electronic device according to claim 5, further comprising a display configured to display the changed parameter and an image in which color information is converted based on the changed parameter.

8. The electronic device according to claim 7, wherein the display is further configured to display the parameter before being changed by the user operation.

9. A management system comprising:
the electronic device according to claim 1; and
a server connected to the electronic device via a network and configured to manage the setting data.

10. A non-transitory computer-readable storage medium storing program for causing a computer to operate as the electronic device according to claim 1.
